(19) United States
(12) Patent Application Publication
(10) Pub. No.: US 2007/0047019 A1
(43) Pub. Date: Mar. 1, 2007

(54) Device and method for processing images

(76) Inventor: Tetsuya Toyoda, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/512,930

(22) Filed: Aug. 30, 2006

(30) Foreign Application Priority Data
Aug. 31, 2005 (JP) 2005-251106

(51) Int. Cl. H04N 1/40

(52) U.S. Cl. 358/448; 358/521

(57) ABSTRACT

An image processing device includes a reduced image generating section which generates reduced image data of input image data. A gradation conversion characteristics deriving section derives gradation conversion characteristics when the input image data is subjected to gradation conversion processing based on the generated reduced image data. A white balance control information deriving section derives information to control white balance of the input image data based on the generated reduced image data. A white balance control section controls the white balance of the input image data based on the derived information to control the white balance. A gradation converting section subjects the image data output from the white balance control section to gradation conversion processing based on the extracted gradation conversion characteristics.

### CROSS-REFERENCE TO RELATED APPLICATIONS

This application is based upon and claims the benefit of priority from prior Japanese Patent Application No. 2005-251106, filed Aug, 31, 2005, the entire contents of which are incorporated herein by reference.

### BACKGROUND OF THE INVENTION

1. Field of the Invention

The present invention relates to a device and a method for processing images, and more particularly to a device and a method for processing images, which perform an adaptive gradation conversion process for the images.

2. Description of the Related Art

Gradation representation of an image is one of important factors to decide its quality. Normally, a signal output from an imaging device is almost proportional to an amount of a light applied to the imaging device. The output signal from the imaging device is subjected to a certain gradation conversion process in accordance with a last image observation environment (e.g., image observation by a monitor, image observation based on a printer output, or the like) in subsequent image processing. For example, in the case of a general digital camera, an sRGB color space is employed as a standard color space of an image file format. In the case of the digital camera, a gray scale of a photographed image is designed to be optimal when it is displayed on a monitor having gamma characteristics (γ=2.2) defined by sRGB.

Generally, gradation conversion characteristics of an image are fixed to one type for each input device such as a digital camera, or selected from a plurality of gradation conversion characteristics by a user or the like. Recently, a technology has begun to be used which adaptively optimizes gradation characteristics for each image in accordance with a luminance distribution of images (or scenes). It is because as a dynamic range of an object field varies from scene to scene, when conversion is carried out by uniform gradation conversion characteristics without taking this variance into account, it is difficult to efficiently reflect luminance information of the object field in a dynamic range of an output device such as a monitor or a printer.

As one of such technologies of adaptively optimizing gradation conversion characteristics for each image, a histogram equalization method is available. According to this technology, a luminance information amount of an image is increased by executing gradation conversion to uniform a luminance histogram (frequency count of each luminance gradation level) of the image, and a gray scale is efficiently allocated to the output device.

According to an exemplary technology disclosed in Jpn. Pat. Appln. Publication No. 2004-297439, gray scale values equivalent to a highlight and a shadow of an image are determined from an image histogram, and gray scales are optimized by correcting a density or the like to set its difference (i.e., dynamic range) to a predetermined value.

### BRIEF SUMMARY OF THE INVENTION

According to a first aspect of the present invention, there is provided an image processing device comprising:

a reduced image generating section which generates reduced image data of input image data;

a gradation conversion characteristics deriving section which derives gradation conversion characteristics when the input image data is subjected to gradation conversion processing based on the generated reduced image data;

a white balance control information deriving section which derives information to control white balance of the input image data based on the generated reduced image data;

a white balance control section which controls the white balance of the input image data based on the derived information to control the white balance; and

a gradation converting section which subjects the image data output from the white balance control section to gradation conversion processing based on the derived gradation conversion characteristics.

According to a second aspect of the present invention, there is provided an image processing device comprising:

a reduced image generating section which generates reduced image data of input image data;

a histogram calculating section which calculates a histogram of the generated reduced image data;

a gradation conversion characteristics deriving section which derives gradation conversion characteristics when the input image data is subjected to gradation conversion processing based on the calculated histogram;

a white balance control information deriving section which derives information to control white balance of the input image data based on the generated reduced image data;

a white balance control section which controls the white balance of the input image data based on the derived information to control the white balance; and

a gradation converting section which subjects the image data output from the white balance control section to gradation conversion processing based on the derived gradation conversion characteristics.

According to a third aspect of the present invention, there is provided an image processing method comprising:

generating reduced image data of input image data;

deriving gradation conversion characteristics when the input image data is subjected to gradation conversion processing based on the generated reduced image data;

deriving information to control white balance of the input image data based on the generated reduced image data;

controlling the white balance of the input image data based on the derived information to control the white balance; and

subjecting the image data whose white balance has been controlled to gradation conversion processing based on the derived gradation conversion characteristics.

According to a fourth aspect of the present invention, there is provided an image processing method comprising:

generating reduced image data of input image data;

calculating a histogram of the generated reduced image data;

deriving gradation conversion characteristics when the input image data is subjected to gradation conversion processing based on the calculated histogram;

derived information to control white balance of the input image data based on the generated reduced image data;

controlling the white balance of the input image data based on the derived information to control the white balance; and

subjecting the image data whose white balance has been controlled to gradation conversion processing based on the derived gradation conversion characteristics.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a conceptual configuration of an image processing device according to an embodiment of the present invention;

FIG. 2 is a block diagram showing a configuration of a digital camera as an example of an image recorder including the image processing device of the embodiment of the present invention;

FIG. 3A is a conceptual diagram when image data is divided into a plurality of blocks;

FIG. 3B is a diagram showing a block integrated value;

FIG. 4 is a diagram showing the number of divided blocks corresponding to a scene mode;

FIG. 5 is a diagram showing an example of a default gradation conversion table;

FIG. 6 is a diagram showing an example of noise characteristic information;

FIG. 7 is a diagram showing an example of a gradation combination ratio;

FIG. 8 is a flowchart showing photographing control including an image processing method according to an embodiment of the present invention;

FIG. 9 is a diagram showing an example of a histogram;

FIG. 10 is a flowchart showing a histogram correcting process;

FIG. 11 is a diagram showing a histogram after frequency value limitation;

FIG. 12 is a diagram showing an example of an accumulative histogram;

FIG. 13 is a flowchart showing a gradation conversion table calculation process;

FIG. 14 is a diagram showing a combination example of a default gradation conversion table and an accumulative histogram;

FIG. 15A is a diagram showing an example of a gradation combination ratio in an automatic exposure mode; and

FIG. 15B is a diagram showing an example of a gradation combination ratio in a manual exposure mode.

### DETAILED DESCRIPTION OF THE INVENTION

An embodiment of the present invention will be described below with reference to the accompanying drawings.

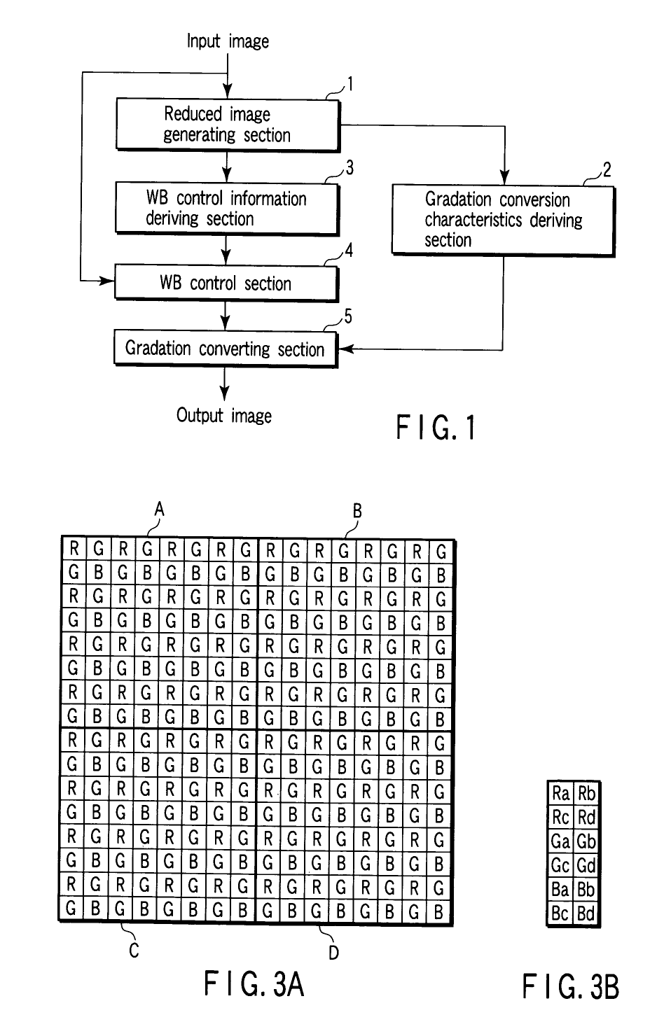

FIG. 1 is a diagram showing a conceptual configuration of an image processing device according to an embodiment of the present invention. The image processing device shown in FIG. 1 includes a reduced image generating section 1, a gradation conversion characteristics deriving section 2, a white balance (WB) control information deriving section 3, a WB control section 4, and a gradation converting section 5.

The reduced image generating section 1 generates reduced image data of input image data. The gradation conversion characteristic deriving unit 2 derives gradation conversion characteristics (gradation conversion table) to subject the input image data to gradation conversion from the reduced image data generated by the reduced image generating section 1. The WB control information deriving unit 3 derives information to control white balance of an input image from the reduced image data generated by the reduced image generating section 1. The WB control section 4 controls the white balance of the input image data based on the information derived by the WB control information deriving section 3 to control the white balance. The gradation converting section 5 subjects the image data whose white balance bas been controlled by the WB control section 4 to gradation conversion based on the gradation conversion table derived by the gradation conversion characteristics deriving section 2 to output the obtained image data to the external device.

Thus, according to the embodiment, as the gradation conversion table and the white balance control information can be derived based on the reduced image data, these processes can be carried out fast, and a capacity of a memory necessary for the processes can be reduced. Moreover, it is possible to generate the reduced image data used for deriving the gradation conversion table and the reduced image data used for deriving the white balance control information by one reduced image generating section.

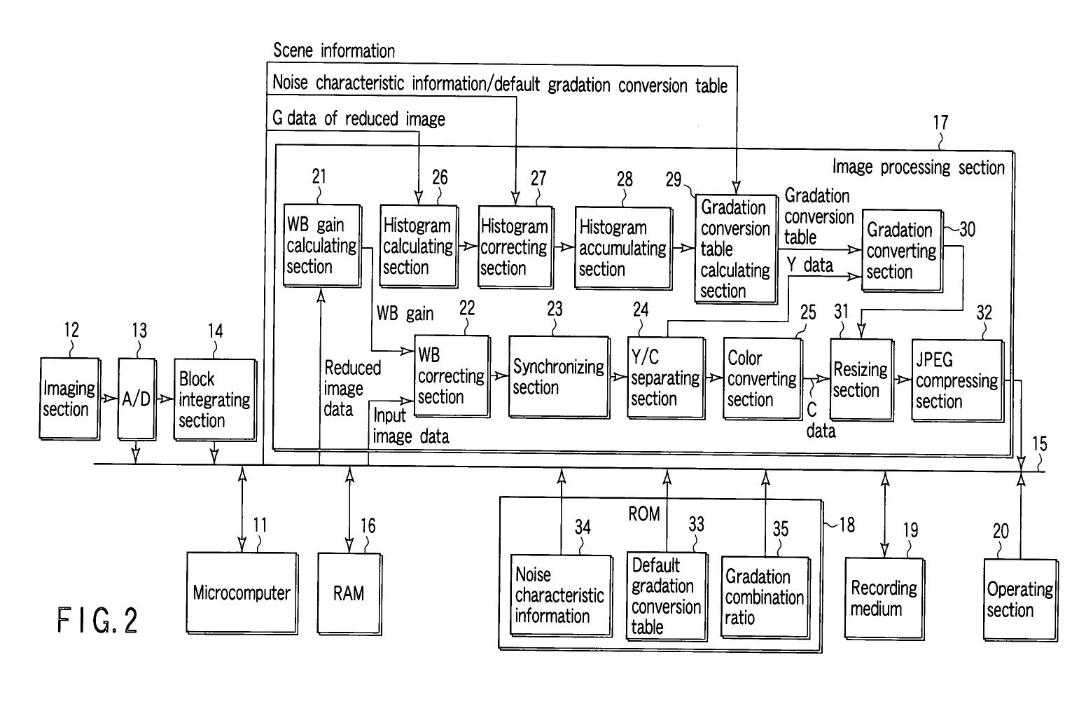

The image processing device of FIG. 1 will be described below more specifically. FIG. 2 is a block diagram showing a configuration of a digital camera (referred to as a camera hereinafter) including the image processing device of the embodiment of the present invention.

As shown in FIG. 2, this digital camera includes a microcomputer 11, an imaging section 12, an analog/digital converting section 13, a block integrating section 14, a bus 15, a RAM 16, an image processing section 17, a ROM 18, a recording medium 19, and an operating section 20.

The microcomputer 11 is a control section in charge of overall control of the camera. The microcomputer 11 executes focus control of a photographic optical system and exposure control of an imaging device in the imaging section 12, recording control when image data is recorded in the recording medium 19, or the like.

The imaging section 12 includes the photographic optical system, the imaging device, a driving section for driving these components, and the like. The imaging section 12 converts a beam of light applied from an object (not shown) via the photographic optical system into an electric signal at the imaging device. The analog/digital converting section 13 converts the electric signal obtained from the imaging section 12 into digital data to generate image data.

The block integrating section 14 corresponding to the reduced image generating section 1 of FIG. 1 integrates image data obtained at the analog/digital converting section 13 for each predetermined block to generate reduced image data used for deriving a gradation conversion table and white balance (WB) control information.

The reduced image data generation process of the block integrating section 14 will be described. FIG. 3A is a conceptual diagram of block division when a pixel array in the imaging device is Bayer array. As shown in FIG. 3A, the imaging device of the Bayer array is configured by alternately arranging a line having pixels alternately arranged to detect red (R) and green (G) components and a line having pixels alternately arranged to detect G and blue (B) components in a columnar direction. Such a pixel arrangement is configured by disposing color filters corresponding to the Bayer array in the front of the pixels.

The reduced image data is obtained by dividing image data into blocks having a predetermined number of pixels, and integrating pixel values of identical color pixels in the divided blocks. For example, in an example of FIG. 3A, image data is divided into four blocks A, B, C and D, an 8×8 pixels constituting one block (area), and integrating pixel values of identical color pixels for the divided blocks A to D. FIG. 3B shows a block integrated value obtained after integration. Through integration for the blocks, block integrated values Ra, Ga and Ba are obtained from the block A, block integrated values Rb, Gb and Bb are obtained from the block B, block integrated values Rc, Gc and Bc are obtained from the block C, and block integrated values Rd, Gd and Bd are obtained from the block D.

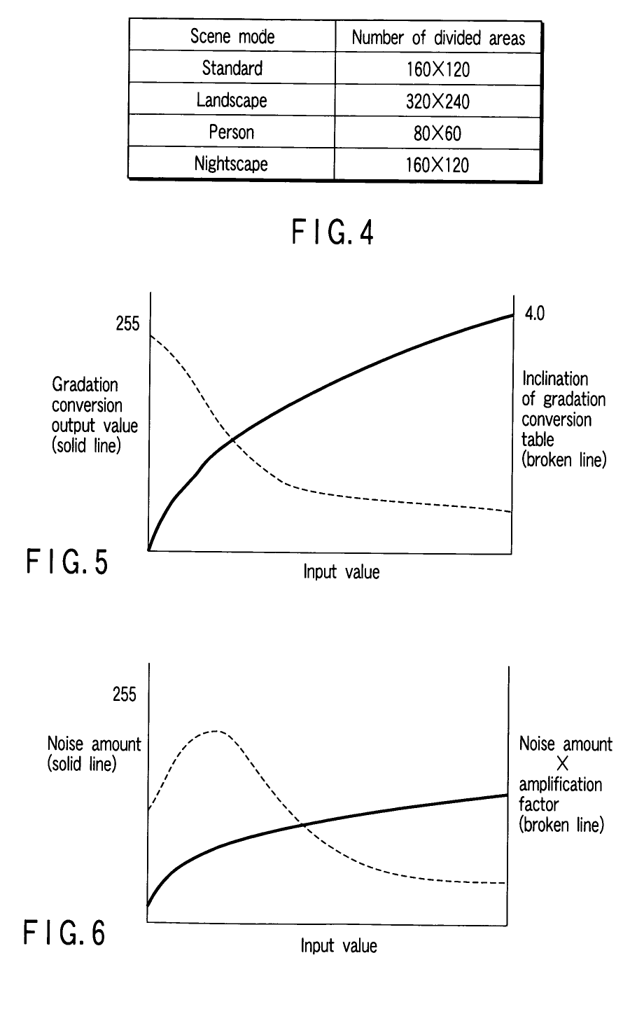

The number of divided blocks during block integration may be a fixed value. However, the number should more preferably be decided according to a scene mode. FIG. 4 shows the number of divided blocks according to the scene mode. The scene mode is one of photographing modes for executing photographing by various settings, in which settings corresponding to various photographing scenes are programmed beforehand. By setting a scene mode, exposure control suited to each scene is automatically performed by the camera side.

A standard mode shown in FIG. 4 is a scene mode for executing photographing not by a specific scene but by standard setting. As shown in FIG. 4, in the standard mode, for example, image data is divided into 160×120 blocks. A nightscape mode is a scene mode for executing photographing by setting suited to nightscape photographing. In the nightscape mode, the number of divided blocks is 160×120. A landscape mode is a scene mode for executing photographing by setting suited to landscape photographing. In the landscape mode, the number of divided blocks is set larger than those of the standard and nightscape modes to enable more accurate acquisition of gradation conversion characteristics than the standard and nightscape modes. In an example of FIG. 4, the number of divided blocks in the landscape mode is 320×240. A person mode is a scene mode for executing photographing by setting suited to person photographing. In the person mode, the number of divided blocks is set smaller than those of the standard and nightscape modes to obtain rougher gradation conversion characteristics than those of the standard and nightscape modes. In the example of FIG. 4, the number of divided blocks in the person mode is 80×60 blocks. The numbers of divided blocks shown in FIG. 4 are only examples, and the numbers of divided blocks are not limited to those of FIG. 4.

The bus 15 is a transfer path for transferring various data such as the image data obtained by the analog/digital converting section 13, the reduced image data obtained by the block integrating section 14, processed data of the image processing section 17, and operation data of the microcomputer 11 to each circuit of the camera. The RAM 16 is a memory for temporarily storing various data such as the reduced image data obtained by the block integrating section 14 and the processed data of the image processing section 17.

The image processing section 17 includes a white balance (WB) gain calculating section 21, a WB correcting section 22, a synchronizing section 23, a Y/C separating section 24, a color converting section 25, a histogram calculating section 26, a histogram correcting section 27, a histogram accumulating section 28, a gradation conversion table calculating section 29, a gradation converting section 30, a resizing section 31, and a JPEG compressing section 32. The histogram calculating section 26, the histogram correcting section 27, the histogram accumulating section 28, and the gradation conversion table calculating section 29 correspond to the gradation conversion characteristics extracting section 2 of FIG. 1. The WB gain calculating section 21, the WB correcting section 22, and the gradation converting section 30 respectively correspond to the WB control information deriving section 3, the WB control section 4, and the gradation converting section 5 of FIG. 1. Image processing of the image processing section 17 thus configured will be described below in detail.

The ROM 18 is a memory for storing various control programs and various camera setting values. The ROM 18 further stores a default gradation conversion table 33, noise characteristic information 34, and a gradation combination ratio 35. These are used for calculation of a gradation conversion table described below.

The default gradation conversion table 33 is a gradation conversion table having standard characteristics, and stored as characteristics fixed for each camera in the ROM 18. FIG. 5 shows an example of the default gradation conversion table 33 indicated by a solid line. An abscissa of FIG. 5 indicates an image input value, i.e., a pixel value of the reduced image data input from the block integrating section 14. An ordinate of a left side of FIG. 5 indicates an output value (8-bit output in the shown example) after gradation conversion. The default gradation conversion table stored in the ROM 18 is not limited to one shown in FIG. 5. For example, a plurality of different default gradation conversion tables may be stored, and a user may optionally select a default gradation conversion table. Alternatively, depending on photographing conditions, an optimal default gradation conversion table may automatically be selected from a plurality of default gradation conversion tables.

The noise characteristic information 34 is information regarding noise characteristics. In other words, the noise characteristic information 34 indicates how much and how noise is superposed in an image during image photographing. The noise characteristic information 34 is also stored as a fixed value in the ROM 18. FIG. 6 shows the noise characteristic information 34 indicated by a solid line. As in the case of FIG. 5, an abscissa of FIG. 6 indicates a pixel value of the reduced image data input from the block integrating section 14. An ordinate of a left side of FIG. 6 indicates an amount of noise. As shown in FIG. 6, an increase of an input value is accompanied by an increase in the amount of noise. In FIG. 6, noise is superposed even when the input value is 0. This noise is generated because of a dark current component.

In this case, as the noise characteristic information 34 changes in amount in accordance with photographing sensitivities, a temperature, exposure time or the like during photographing, plural pieces of noise characteristic information may be stored in the ROM 18 corresponding to a change in photographing sensitivities, temperature or exposure time. For example, in the case of high photographing sensitivities, an amount of noise is set higher in noise characteristic information than normal. During photographing of image data, noise characteristic information corresponding to photographing sensitivities, a temperature or exposure time at the time is read.

Regarding recent cameras, a camera having a noise reduction processing function for reducing noise of an image during photographing has been proposed. Noise characteristic information correspondingly set in a noise reduced state (noise amount is smaller than normal) may be stored in the ROM 18.

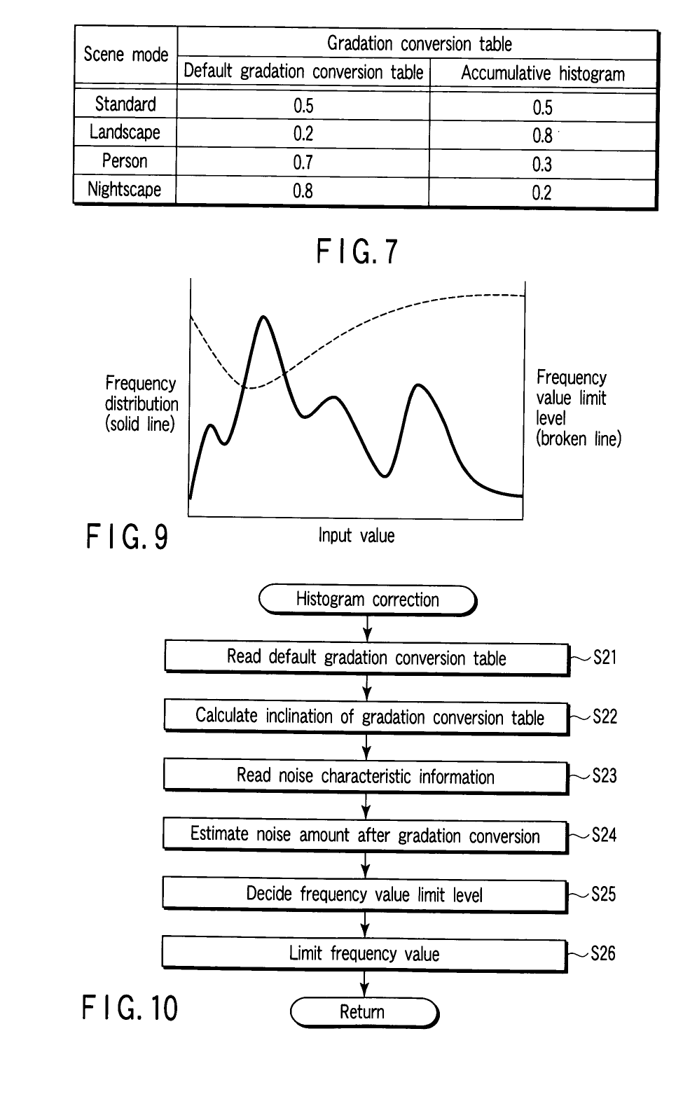

The gradation combination ratio 35 is a combination ratio when the default gradation conversion table 33 is combined with an accumulative histogram described below. FIG. 7 shows an example of a gradation combination ratio. As shown in FIG. 7, for the gradation combination ratio 35, a value compliant with a scene mode is stored. FIG. 7 shows gradation combination ratios corresponding to the standard mode, the landscape mode, the person mode, and the nightscape mode as gradation combination ratios corresponding to scene modes. However, these ratios are in no way limitative. Values shown in FIG. 7 can be changed.

The recording medium 19 is a recording medium in which the image data processed by the image processing section 17 is recorded. For example, the recording medium 19 includes a memory card or the like.

The operating section 20 is a member for various operations operated by the user. When the user operates the operating section 20, control of various types is performed by the microcomputer 11 in accordance with its operation state. For example, the operating section 20 includes a selection member for selecting a scene mode or the like and a release button for instructing photographing execution.

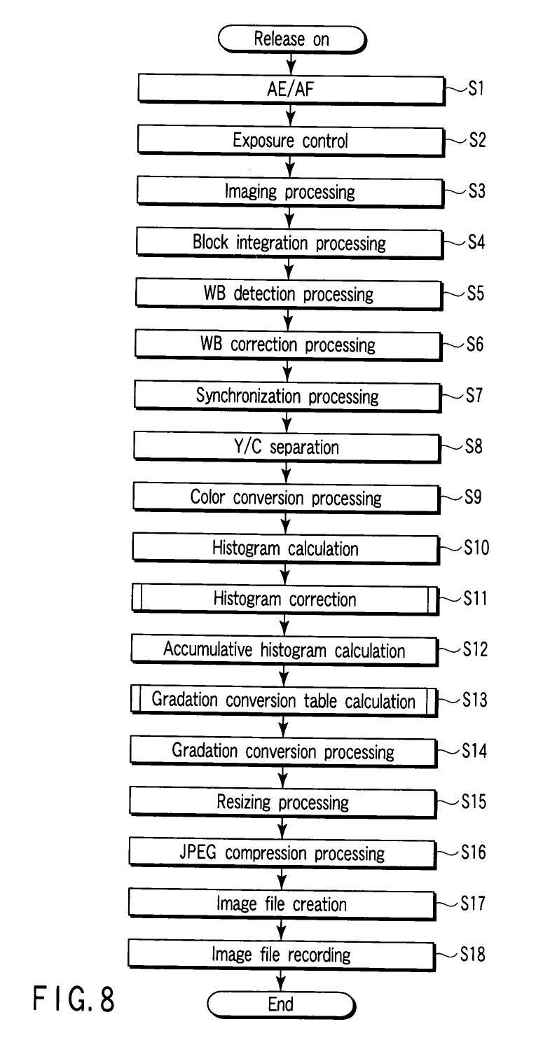

Photographing control of a camera having a configuration similar to that of FIG. 2 will be described by referring to FIG. 8. FIG. 8 is a flowchart showing a photographing control procedure including an image processing method according to an embodiment of the present invention. The flowchart of FIG. 8 is started when the user turns on the release button.

When the user turns on the release button, well-known AE processing and AF processing are executed (step S1). For the AE processing and the AF processing, depending on camera types, for example, there are a method executed based on an output of an AE sensor or an AF sensor, and a method executed based on an image obtained by the imaging section 12 (not an output of the block integrating section 14 but an output of the analog/digital converting section 13). After the AE processing and the AF processing, exposure control is carried out (step S2). In the exposure control, opening time of a shutter (not shown) and an aperture amount of an aperture (not shown) are controlled in accordance with scene mode setting or the like, whereby exposure of the imaging device of the imaging section 12 is controlled. Through the exposure control, an image signal for recording is obtained at the imaging section 12. Subsequently, imaging processing is executed for the image signal obtained at the imaging section 12 (step S3). Through the imaging processing, the imaging signal obtained at the imaging section 12 is read to be converted into a digital image data by the analog/digital converting section 13. The image data obtained by the analog/digital converting section 13 is input to the block integrating section 14 and the WB correcting section 22 of the image processing section 17.

At the block integrating section 14, reduced image data is generated from the image data input from the analog/digital converting section 13 (step S4). The reduced image data is generated by integration for predetermined blocks in accordance with the scene mode shown in FIG. 4 as described above. The reduced image data obtained at the block integrating section 14 is input to the WB gain calculating section 21 and the histogram calculating section 26. At the WB gain calculating section 21, a white balance (WB) gain is calculated as WB control information from the input reduced image data (step S5). For the WB gain, R and B gains in which a white color of the input reduced image data is set as a predetermined standard white color are calculated. At the WB correcting section 22, image data input from the analog/digital converting section 13 is subjected to WB correction (step S6). The WB correction is carried out by multiplying an R component of the image data input from the analog/digital converting section 13 by the R gain calculated at the WB gain calculating section 21 and multiplying a B component by the B gain. The image data subjected to WB correction at the WB correcting section 22 is input to the synchronizing section 23.

At the synchronizing section 23, the input image data is subjected to synchronization processing (step S7). In the synchronization processing, image data having three colors of RGB to constitute one pixel component is generated from the image data of the Bayer array input to the synchronizing section 23 by interpolation. The image data subjected to synchronization processing is input to the Y/C separating section 24.

At the Y/C separating section 24, the input image data is subjected to Y/C separation processing (step S8). In the Y/C separation processing, the input image data is separated into a Y (luminance) signal and C (color) signals. The Y signal of the separated signals is input to the gradation converting section 30, and the C signals are input to the color converting section 25.

At the color converting section 25, the input C signals are subjected to color conversion processing (step S9). In the color conversion processing, the C signals input to the color converting section 25 are converted into standard color signals of sRGB or the like. The signals color-converted by the color converting section 25 are input to the resizing section 31.

At the histogram calculating section 26, histogram calculation processing is carried out based on the reduced image data input from the block integrating section 14 (step S10). In the histogram calculation processing, a luminance histogram of a G component of the reduced image data input to the histogram calculating section 26 is calculated. A solid line of FIG. 9 indicates an exemplary histogram calculated by the histogram calculating section 26. An abscissa of FIG. 9 indicates a luminance input value (pixel value of the G component). An ordinate of a left side of FIG. 9 indicates a luminance distribution, i.e., a frequency value of luminance inputting. The histogram calculated by the histogram calculating section 26 is input to the histogram correcting section 27.

At the histogram correcting section 27, histogram correction processing is carried out to correct the input histogram (step S11). This histogram correction processing will be described below.

After the histogram correction processing at the histogram correcting section 27, the corrected histogram is input to the histogram accumulating section 28. At the histogram accumulating section 28, histogram accumulation processing will be carried out (step S12). In the histogram accumulation processing, histograms input to the histogram accumulating section 28 are sequentially accumulated from a low-luminance component side. The accumulative histogram obtained at the histogram accumulating section 28 is input to the gradation conversion table calculating section 29. At the gradation conversion table calculating section 29, gradation conversion table calculation processing is executed (step S13). This gradation conversion table calculation processing will be described below.

The gradation conversion table calculated at the gradation conversion table calculating section 29 is input to the gradation converting section 30. At the gradation converting section 30, gradation conversion processing is carried out (step S14). In the gradation conversion processing, the Y signal input from the Y/C separating section 24 is subjected to gradation conversion based on the gradation conversion table input from the gradation conversion table calculating section 29. At the resizing section 31, the Y signal subjected to gradation conversion and the C signals subjected to color conversion are resized by a method such as interpolation calculation or the like in accordance with an image size during recording (step S15). At the JPEG compressing section 32, the resized Y and C signals are subjected to JPEG compression (step S16). After the JPEG compression processing, photographing information such as a scene mode or exposure conditions is added as header information to the data subjected to JPEG compression to create an image file (step S17). Subsequently, the created image file is recorded in the recording medium 19 (step S18). Thus, the photographing control is finished.

Next, the histogram correction processing of the step S11 of FIG. 8 will be described by referring to FIG. 10. In the histogram correction processing, first, the default gradation conversion table 33 stored in the ROM 18 is read (step S21). Then, inclination of the default gradation conversion table 33 is calculated (step S22). In this case, the inclination of the default gradation conversion table 33 is obtained by differentiating the default gradation conversion table 33. For example, when the default gradation conversion table 33 is as indicated by the solid line of FIG. 5, its inclination is indicated by a broken line of FIG. 5.

After the calculation of the default gradation conversion table 33, the noise characteristic information 34 stored in the ROM 18 is read (step S23). Then, an amount of noise after gradation conversion is estimated (step S24). The amount of noise after the gradation conversion is a product of a noise amount and an amplification factor of noise after gradation conversion. As the amplification factor of noise after the gradation conversion is represented by the inclination of the default gradation conversion table 33 calculated in the step S22, the amount of noise after the gradation conversion becomes a product of the noise amount indicated by the solid line of FIG. 6 and the inclination of the default gradation conversion table indicated by the broken line of FIG. 6. Accordingly, the amount of noise after the gradation conversion is indicated by the broken line of FIG. 7. As indicated by the broken line of FIG. 7, after the gradation conversion, a peak of the noise amount exists in a dark part of the original image. This is because the dark part of the original image is extended and a bright part is compressed through the gradation conversion.

Upon estimation of the noise amount after the gradation conversion, to correct the histogram, a frequency value limit level of the histogram is decided (step S25). In this case, a histogram frequency value is limited to prevent conspicuousness of the noise after the gradation conversion. Thus, an inverse number of the noise amount after the gradation conversion is calculated as a frequency value limit level. The frequency value limit level is indicated by a broken line of FIG. 9. As shown in FIG. 9, a limit level of a frequency value is higher in a part in which a noise amount after gradation conversion is larger.

The frequency value limit level of the histogram is set to be the inverse number of the noise amount after the gradation conversion. However, for example, by performing predetermined calculation after the calculation of the inverse number, a more proper frequency value limit level may be obtained.

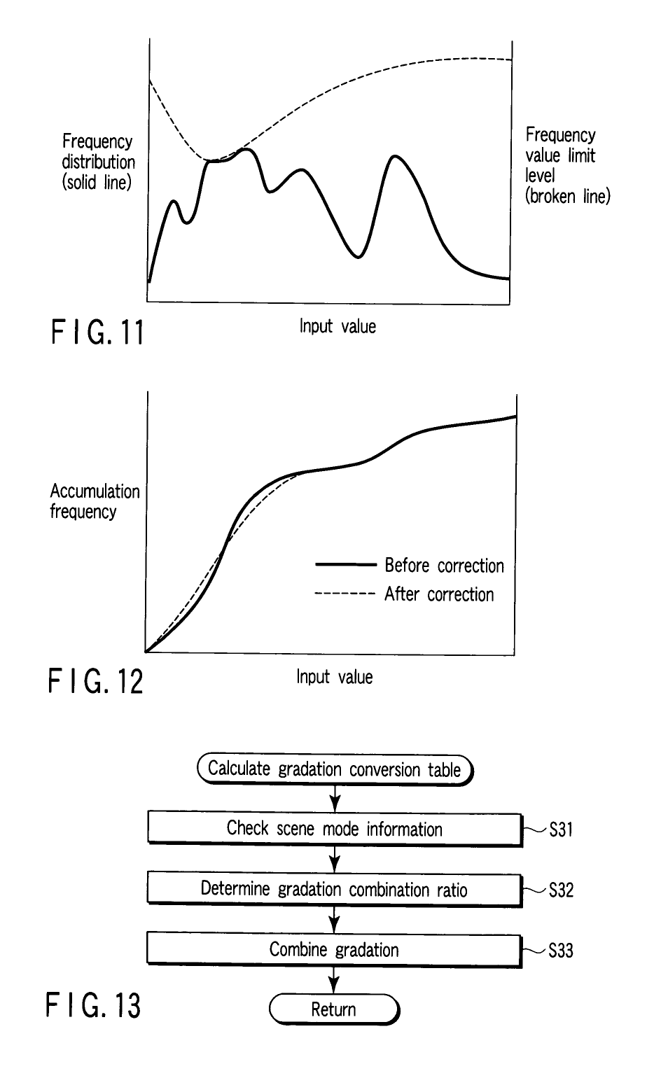

After the frequency value limit level has been decided, a part of the histogram exceeding the frequency value limit level is limited as shown in FIG. 11 (step S26). Accordingly, through the gradation conversion carried out by using the corrected histogram, it is possible to prevent conspicuousness of noise after the gradation conversion.

FIG. 12 shows an example of an accumulative histogram obtained after histogram accumulation processing. An accumulative histogram before histogram correction of the histogram correcting section 27 is indicated by a solid line of FIG. 12, and an accumulative histogram after histogram correction of the histogram correcting section 27 is indicated by a broken line of FIG. 12. In the case of the accumulative histogram after the histogram correction, a maximum value (equivalent to a total frequency count) of accumulation frequency is normalized to match a maximum value of accumulation frequency before the histogram correction. As shown in FIG. 12, in the case of the accumulative histogram after the histogram correction, inclination of a part in which a noise amount after gradation conversion is increased becomes gentle as compared with the cumulative histogram before the histogram correction.

Next, referring to FIG. 13, gradation conversion table calculation processing will be described. In the gradation conversion table calculation processing, the accumulative histogram obtained by the histogram accumulating section 28 and the default gradation conversion table 33 stored in the ROM 18 are combined together by a predetermined combination ratio to calculate a gradation conversion table.

In FIG. 13, first, scene mode information during photographing is checked (step S31). Which of gradation combination ratios stored in the ROM 18 should be selected is determined in accordance with the scene mode information checked in the step S31 (step S32). Then, the default gradation conversion table 33 and the accumulative histogram are combined together in accordance with the determined gradation combination ratio (step S33).

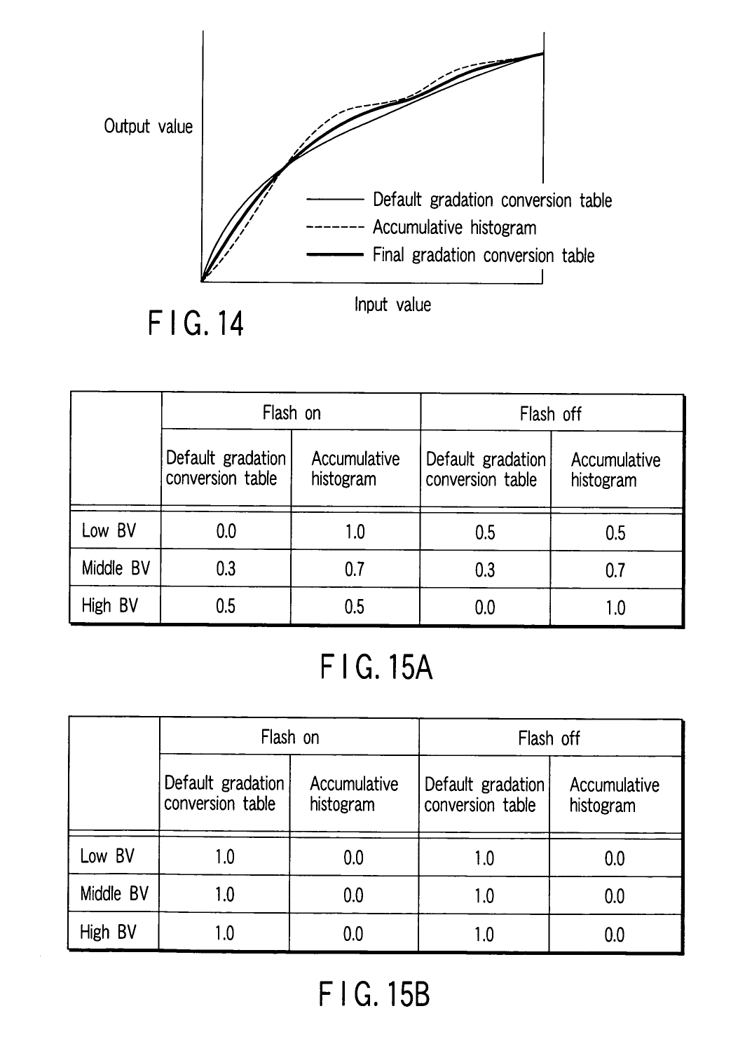

FIG. 14 shows an exemplary combination of the default gradation conversion table 33 and the accumulative histogram. A thin solid line of FIG. 14 indicates a default gradation conversion table, a broken line of FIG. 14 indicates an accumulative histogram, and a thick solid line of FIG. 14 indicates a final gradation conversion table obtained after combining. In the example of FIG. 14, a scene mode is a standard mode (gradation combination ratio shown in FIG. 7 is 0.5:0.5). Thus, in the example of FIG. 14, because of the gradation combination ratio 0.5:0.5, a gradation conversion table obtained after combining becomes equal to an average value of the default gradation conversion table 33 and the accumulative histogram.

In the case of photographing an object of high contrast such as a landscape shown in FIG. 7, more proper gradation representation is realized by setting a ratio of the accumulative histogram higher (0.2:0.8 in FIG. 7). Conversely, in the case of a person, because of low contract of an object, importance is placed on the default gradation conversion table to prevent an increase of contrast more than necessary (0.7:0.3 in FIG. 7). In the case of a nightscape, a ratio of the default gradation conversion table is set higher to prevent an image which is originally dark from becoming bright (0.8:0.2 in FIG. 7). In the case of the nightscape, the default gradation conversion table and the accumulative histogram may not be combined together.

The gradation combination ratio is not limited to the storage of the value alone corresponding to the scene mode. For example, a gradation combination ratio based on presence of a light emitted from a flash or setting of manual or automatic execution of exposure may simultaneously be stored.

FIG. 15A shows an example of a gradation combination ratio in an automatic exposure mode for automatically controlling exposure by a camera side. As shown in FIG. 15A, in the case of the automatic exposure mode, a gradation combination ratio is decided in accordance with object luminance (BV) during photographing, photographing sensitivity information of the imaging section 12 during photographing, and flash information indicating on/off of flash light emission.

In FIG. 15A, for example, if luminance of the object is low (low BV), a photographing sensitivity of the imaging section 12 is low, and the flash is on, image contrast becomes high. Accordingly, a ratio of the accumulative histogram is set higher to prevent blackening of an image of a dark part. On the other hand, if luminance of the object is high (high BV), a photographing sensitivity of the imaging section 12 is low, and the flash is on, there is a possibility that the user turns on the flash to correct backlighting. Accordingly, ratios of the default gradation table and the accumulative histogram are set approximately equal to each other.

If luminance of the object is low, a photographing sensitivity of the imaging section 12 is low, and the flash is off, there is a possibility that the user intentionally turns off the flash. Thus, ratios of the default gradation table and the accumulative histogram are set approximately equal to each other. Further, if luminance of the object is high, a photographing sensitivity of the imaging section 12 is low, and the flash is off, a ratio of the accumulative histogram is set higher to carry out more proper gradation representation.

If a photographing sensitivity of the imaging section 12 is set high, the image becomes bright as a whole. Accordingly, a ratio of the accumulative histogram is set lower than that in the case of a low sensitivity to prevent a dark part from becoming bright more than necessary.

FIG. 15B shows an example of a gradation combination ratio in a manual exposure mode for manually controlling exposure. As shown in FIG. 15B, in the manual exposure mode, to sufficiently reflect user's image creation intension, the default gradation conversion table alone is used without combining the accumulative histogram.

As described above, according to the embodiment, the reduced image data obtained by the block integrating section can be used for calculating the white balance gain and the gradation conversion table. Thus, it is possible to carry out derivation of the gradation conversion table and calculation of the white balance gain at a high speed without increasing a circuit size or a memory.

According to the embodiment, the reduced image data is used for calculating the white balance gain and extraction of the gradation conversion characteristics. However, the reduced image data may be used as a thumbnail image. As the thumbnail image is generally generated based on the number of divided blocks 160 x 120, the reduced image data obtained by the block integrating section 14 can be directly used as a thumbnail image in the standard mode or the nightscape mode. In the case of the landscape mode, the number of blocks of the reduce image data obtained by the block integrating section 14 only needs to be reduced by interpolation calculation or block integration. In the person mode, the number of blocks of the reduced image data obtained by the block integrating section 14 only needs to be increased by interpolation calculation or the like. For example, such processing can be carried out at the resizing section 31. In this case, the block integrating section 14 and the resizing section 31 can be said to be a thumbnail image generating section.

According to the embodiment, the gradation conversion table is derived by using the histogram. However, it is not always necessary to use the histogram for deriving the gradation conversion table.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image processing device comprising:
a reduced image generating section which generates reduced image data of input image data;
a gradation conversion characteristics deriving section which derives gradation conversion characteristics when the input image data is subjected to gradation conversion processing based on the generated reduced image data;
a white balance control information deriving section which derives information to control white balance of the input image data based on the generated reduced image data;
a white balance control section which controls the white balance of the input image data based on the derived information to control the white balance; and
a gradation converting section which subjects the image data output from the white balance control section to gradation conversion processing based on the derived gradation conversion characteristics.

2. An image processing device comprising:
a reduced image generating section which generates reduced image data of input image data;
a histogram calculating section which calculates a histogram of the generated reduced image data;
a gradation conversion characteristics deriving section which derives gradation conversion characteristics when the input image data is subjected to gradation conversion processing based on the calculated histogram;
a white balance control information deriving section which derives information to control white balance of the input image data based on the generated reduced image data;
a white balance control section which controls the white balance of the input image data based on the derived information to control the white balance; and
a gradation converting section which subjects the image data output from the white balance control section to gradation conversion processing based on the derived gradation conversion characteristics.

3. The image processing device according to claim 1, wherein the reduced image generating section generates the reduced image data by dividing the input image data into a plurality of areas and integrating pixel values of the same color of the divided areas.

4. The image processing device according to claim 2, wherein the reduced image generating section generates the reduced image data by dividing the input image into a plurality of areas and integrating pixel values of the same color of the divided areas.

5. The image processing device according to claim 3, wherein the reduced image generating section controls a size of the reduced image data by controlling the number of divided areas of the image data when the reduced image data is generated.

6. The image processing device according to claim 4, wherein the reduced image generating section controls a size of the reduced image data by controlling the number of divided areas of the image data when the reduced image data is generated.

7. The image processing device according to claim 5, wherein the reduced image generating section controls the number of divided areas in accordance with a scene mode when the image data is obtained.

8. The image processing device according to claim 6, wherein the reduced image generating section controls the number of divided areas in accordance with a scene mode when the image data is obtained.

9. The image processing device according to claim 2, wherein:
the histogram calculating section calculates the histogram from a green component of the reduced image data, and the white balance control information deriving section derives information to control the white balance from three components having red, green and blue components, of the reduced image data.

10. The image processing device according to claim 1, further comprising a thumbnail image generating section which generates a thumbnail image from the reduced image data generated by the reduced image data generating section.

11. The image processing device according to claim 2, further comprising a thumbnail image generating section which generates a thumbnail image from the reduced image data generated by the reduced image data generating section.

12. The image processing device according to claim 1, further comprising a thumbnail image generating section which generates thumbnail image data from the input image data,
wherein the gradation conversion characteristics deriving section derives gradation conversion characteristics when the input image data is subjected to gradation conversion processing based on the generated thumbnail image data.

13. The image processing device according to claim 2, further comprising a thumbnail image generating section which generates thumbnail image data from the input image data, wherein the histogram calculating section calculates a histogram based on the generated thumbnail image data.

14. An image processing method comprising:
generating reduced image data of input image data;
deriving gradation conversion characteristics when the input image data is subjected to gradation conversion processing based on the generated reduced image data;
deriving information to control white balance of the input image data based on the generated reduced image data;
controlling the white balance of the input image data based on the derived information to control the white balance; and
subjecting the image data whose white balance has been controlled to gradation conversion processing based on the derived gradation conversion characteristics.

15. An image processing method comprising:
generating reduced image data of input image data;
calculating a histogram of the generated reduced image data;
deriving gradation conversion characteristics when the input image data is subjected to gradation conversion processing based on the calculated histogram;
deriving information to control white balance of the input image data based on the generated reduced image data;
controlling the white balance of the input image data based on the derived information to control the white balance; and
subjecting the image data whose white balance has been controlled to gradation conversion processing based on the derived gradation conversion characteristics.
